(19) United States
(12) Patent Application Publication
(10) Pub. No.: US 2016/0052397 A1
(43) Pub. Date: Feb. 25, 2016

(54) SYSTEM AND METHOD OF ESTIMATING AVAILABLE DRIVING DISTANCE USING ENERGY CONSUMPTION DATA BINNING

(71) Applicant: FORD GLOBAL TECHNOLOGIES, LLC, DEARBORN, MI (US)

(72) Inventors: Jason MEYER, Canton, MI (US); Shiqi QIU, Dearborn, MI (US); Fling TSENG, Ann Arbor, MI (US); Sangeetha SANGAMESWARAN, Canton, MI (US)

(21) Appl. No.: 14/464,293

(22) Filed: Aug. 20, 2014

(51) Int. Cl. B60L 3/12

(52) U.S. Cl. CPC B60L 3/12

(57) ABSTRACT

A vehicle system for indicating available driving distance includes a display and a controller programmed to store energy consumption data and driving distance data from previous drive cycles. The controller is further programmed to store the previous vehicle drive cycle data according to day of week, and during a current drive cycle, to output via the display an available driving distance. The controller is further configured to generate the available drive distance based on an expected energy consumption rate and an expected driving distance, each corresponding to the day of the week of the current drive cycle.

### TECHNICAL FIELD

The present disclosure relates to battery-powered vehicle powertrain control systems.

### BACKGROUND

Vehicles may be propelled by operation of an electric machine configured to receive electrical power from an on-board battery. The battery may be charged with electrical power from a utility grid or other off-board power source. In circumstances where the battery is the sole propulsion power source, full depletion of the battery may render the powertrain inoperable. This occurrence may require a time consuming battery recharge that inconveniences a vehicle driver. Therefore the driver may wish to accurately know in advance the vehicle's expected available driving distance before the battery is drained.

### SUMMARY

In at least one embodiment, a distance indicator system for a vehicle includes a display and a controller programmed to store energy consumption data and driving distance data from previous drive cycles. The controller is further programmed to store the previous vehicle drive cycle data according to day of week, and during a current drive cycle, to output via the display an available driving distance. The controller is further configured to generate the available drive distance based on an expected energy consumption rate and an expected driving distance, each corresponding to the day of the week of the current drive cycle.

In at least one embodiment, a method of indicating available drive distance for a vehicle includes displaying, on a display, a predicted available driving distance for a current drive cycle of the vehicle that is based on stored energy consumption data and stored driving distance data associated with at least one of a plurality of driving categories. The predicted available driving distance is further based on criteria characterizing the current drive cycle that correlates to criteria defining at least one of the driving categories.

In at least one embodiment, a vehicle includes a powertrain, a user interface display to indicate driving distance information. The vehicle further includes a controller programmed to store, from previous drive cycles, energy consumption data for the powertrain and speed data of the vehicle in speed interval categories. The controller is further programmed to output via the display for a current drive cycle an available driving distance that is based on expected energy consumption and a likelihood of vehicle speed falling within each of the speed interval categories during the current drive cycle.

### BRIEF DESCRIPTION OF THE DRAWINGS

FIG. 1 is a schematic diagram of a vehicle having a battery-powered electric machine.

FIG. 2 is a flowchart depicting a method for calculating available driving distance.

FIG. 3 is a vehicle system diagram illustrating calculation of available driving distance according to an embodiment based on a day of a week.

FIG. 4 is a vehicle system diagram illustrating calculation of available driving distance according to an additional embodiment based on a day of a week.

FIG. 5 is a vehicle system diagram illustrating calculation of available driving distance according to a further additional embodiment based on vehicle speed intervals.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In a vehicle, whether a battery electric vehicle (BEV), hybrid electric vehicle (HEV), or conventional vehicle powered solely by an internal combustion engine, the energy consumption rate may be monitored and learned for a variety of end use features. Various examples include an instantaneous energy consumption rate display, an average consumption rate over the trip odometer, a running average consumption rate for the current drive cycle, and a distance to empty calculation. As a general concern it is important for such calculations to be accurate.

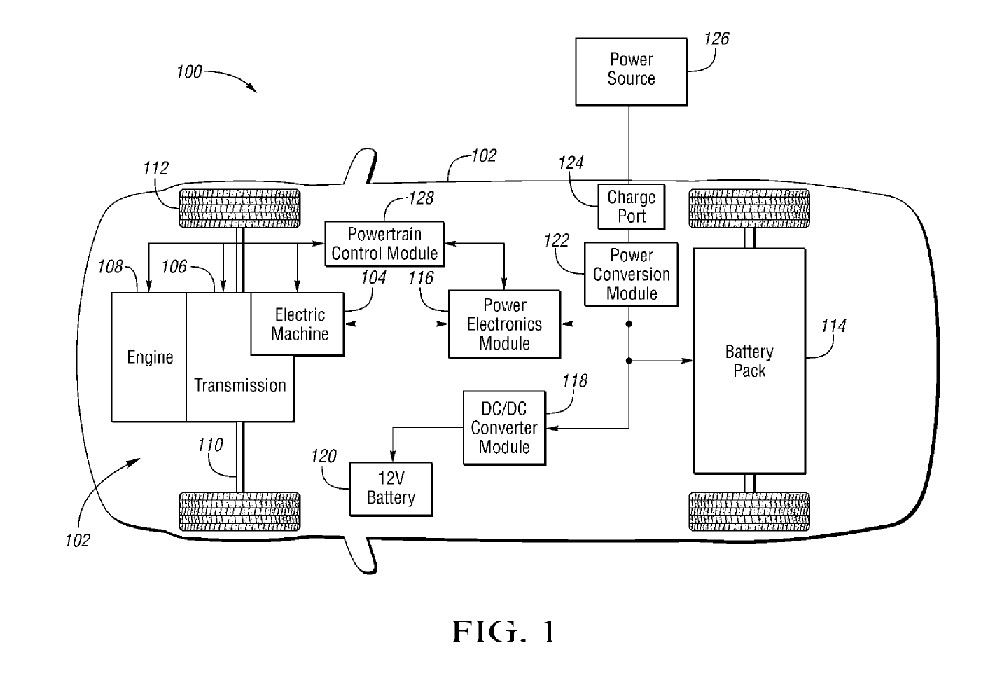

FIG. 1 depicts an example of a plug in hybrid-electric vehicle 100. A hybrid-electric powertrain 102 may include one or more electric machines 104 mechanically connected to a transmission 106. In addition, the transmission 106 is mechanically connected to an engine 108. The transmission 106 may also be mechanically connected to a drive shaft 110 that drives wheels 112. The electric machine 104 can provide vehicle propulsion when the engine 108 is turned on, as well as when the engine is turned off. The electric machine 104 can additionally provide vehicle deceleration by imparting a resistive torque upon the drive shaft. The electric machine 104 may further be configured to operate as an electric generator and provide fuel economy benefits by recovering energy that would otherwise be lost as heat in the friction braking system during deceleration. The electric machine 104 helps to reduce pollutant emissions from the engine when the hybrid electric vehicle 100 is operated in an electric-only powertrain mode.

The traction battery, or battery pack 114, stores energy that can be used to power the electric machine 104. A vehicle battery pack 114 is capable of providing a high voltage DC output. The battery pack 114 is electrically connected to a power electronics module 116. The power electronics module 116 is also electrically connected to the electric machine 104, and provides the ability to bi-directionally transfer energy between the battery pack 114 and the electric machine 104. For example, the battery pack 114 may be configured to provide a DC current where the electric machine 104 may require a three-phase AC current to function. In this case, the power electronics module 116 converts the DC current to a three-phase AC current to be received by the electric machine 104. In a regenerative mode, the power electronics module 116 will convert the three-phase AC current generated by the electric machine 104 to the DC current to be received by the battery pack 114. The methods described in the present disclosure are equally applicable to an all-electric vehicle or any other device using a battery pack.

In addition to providing energy for propulsion, the battery pack 114 may provide energy for other vehicle electrical systems. A DC/DC converter module 118 is capable of converting the high voltage DC output of the battery pack 114 to a low voltage DC supply that is compatible with low voltage vehicle loads. Other high voltage loads, such as an air conditioning compressor and an electric heater, may be connected directly to the high-voltage bus from the battery pack 114. The low voltage systems may also be electrically connected to a 12V battery 120. An all-electric BEV may have a similar architecture but without the engine 108.

The battery pack 114 may be recharged by an external power source 126. The external power source 126 may provide AC or DC power to the vehicle 100 by electrically connecting through a charge port 124. The charge port 124 may be any type of port configured to transfer power from the external power source 126 to the vehicle 100. The charge port 124 may be electrically connected to a power conversion module 122. The power conversion module is configured to condition the power from the external power source 126 to provide the proper voltage and current levels to the battery pack 114. In some applications, the external power source 126 may be configured to provide the proper voltage and current levels to the battery pack 114 such that the power conversion module 122 may not be necessary. For example, the functions of the power conversion module 122 may be contained in the external power source 126.

The vehicle powertrain including the engine, transmission, electric machine and power electronics may be controlled by a powertrain control module (PCM) 128. Although depicted as a single controller, the PCM 128 may comprise a larger control system including several controllers. The individual controllers, or the control system, may be influenced by various other controllers throughout the vehicle 100, where certain controllers operate at a higher command hierarchy relative to other subservient controllers. The term “controller” as used in the present disclosure is intended to encompass at least a system of controllers at it relates to the system and methods discussed herein.

Any of the above-mentioned controllers and power electronics may further include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

In addition to illustrating a plug-in hybrid vehicle, FIG. 1 can be representative of a battery electric vehicle (BEV) if the engine 108 is removed. In the case of a BEV, the battery-powered electric machine 104 may be the sole propulsion source. Likewise, FIG. 1 can represent a traditional hybrid electric vehicle (HEV) or a power-split hybrid electric vehicle if the components 122, 124, and 126 are removed. In each of the electrified vehicle types where the battery is a primary propulsion power source, it is important to accurately calculate the available driving distance, or the distance to empty (“DTE”). Particularly when these vehicles are operated in an electric-only mode, drivers may be heavily reliant upon the vehicle range calculation to ensure that a desired destination is within the available vehicle driving range considering the electrical power stored within the battery.

The vehicle 100 also includes a user interface disposed in an interior portion of the passenger cabin. The interface includes a display to inform the driver of various vehicle operating conditions. A distance indicator system displays driving distance information to facilitate drive planning on the part of the driver. The DTE value displays the available driving distance, and one or more vehicle controllers may update the value as the vehicle is operated. Generally, the DTE may be calculated by equation (1) shown below.

$$D T E ( km ) = \frac{Available Energy ( KWh )}{Average Energy Consumption rate ( KWh \text{/} km )} \qquad ( 1 )$$

How the average energy consumption is calculated is a significant factor in deriving an accurate DTE estimation. Certain calculation methods include averaging overall energy consumption over an extended distance. This may yield inaccurate DTE estimates because frequently customer driving patterns are not always fixed. Using a single value to represent the overall energy consumption history may not be sufficient to account for a vehicle that undergoes varying driving patterns. For example, customers frequently have distinct driving patterns during weekdays (i.e., taking a highway to and from work) as compared to weekend days (i.e., running local errands in a single neighborhood having lower speed limits). In this case, the energy consumption history of weekday driving will reflect more of a highway history. At the beginning of a weekend day, the DTE estimate may not be accurate if based on prior energy consumption rates that do not reflect weekend style driving. Similarly, the energy consumption history may slowly adapt to the city driving style of the weekend, and then when the vehicle is used for highway-focused driving patterns on Monday, the DTE estimate will again be inaccurate. The systems and methods disclosed herein account for the above-mentioned differences in driving styles by binning energy consumption profiles separately based on different driving categories, then recalling the stored energy consumption data at appropriate times for use in DTE calculation.

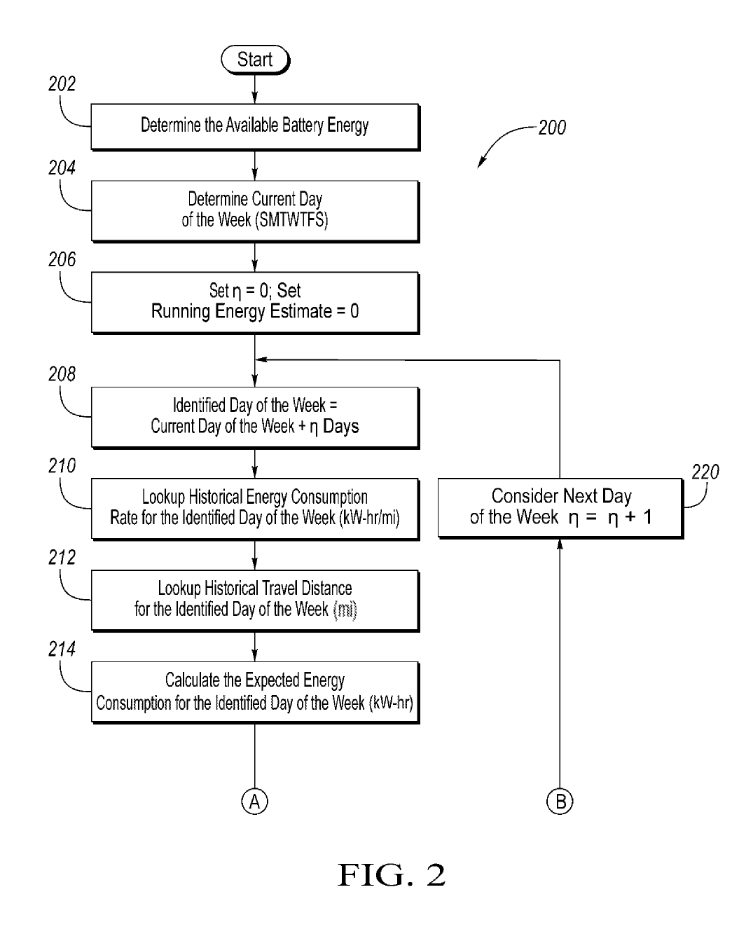

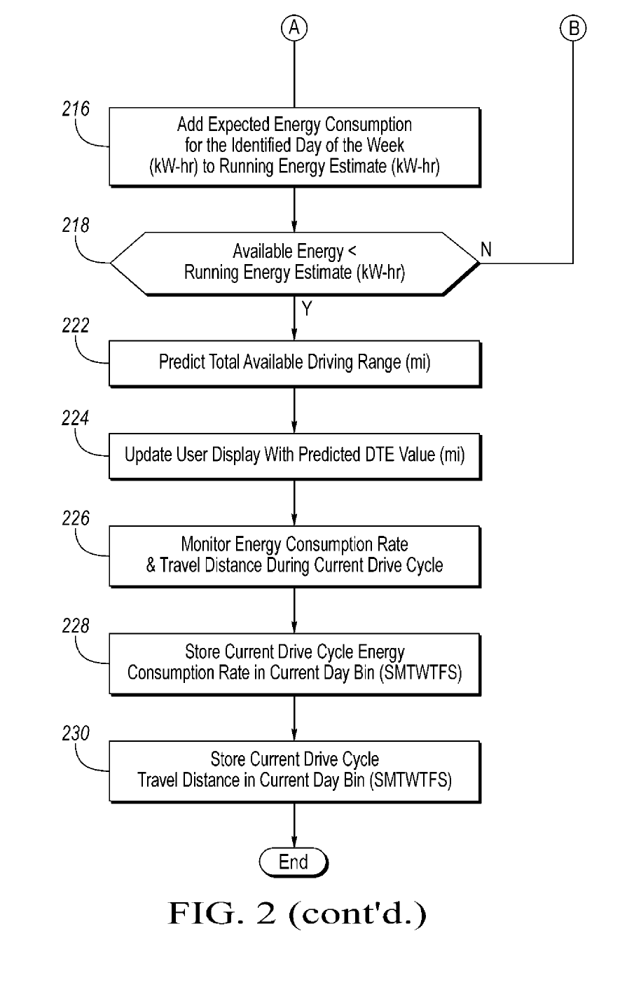

Referring to FIG. 2, a method 200 is depicted to bin energy consumption profiles into separate driving categories based on the days of the week. At step 202, a vehicle controller determines the available energy stored in the battery. The energy may be indicated by a state of charge (SOC) percentage relative to a full charge. Also, an absolute energy value may be used, such as kW-hr to represent available battery energy. The available energy to be used for propulsion may also include a lower threshold to avoid full battery depletion. At step 204 the controller determines the current day of the week. The controller may reference the current day of the week to look up stored data concerning energy consumption to predict energy usage during upcoming drive cycles. A drive cycle may be defined as the duration of powertrain activation from a key-on time to a key-off time. Alternatively, a drive cycle may encompass all driving activity that occurs during a single day. At step 206 the controller may set a counter value η to zero to maintain a reference to the current day of the week. With η=0, the controller recognizes at step 208 an identified day of the week as the current day plus η days. In the initial case, the identified day will be equal to the current day. Also, at step 206 the controller may set a placeholder zero value for a running energy estimate to be updated using subsequent calculations discussed in more detail below.

At step 210, the controller looks up historical energy consumption rate data stored in memory within bins according to days of the week. Particularly, the controller recalls the consumption data corresponding to the identified day of the week. Similarly, at step 212 the controller looks up historical trip distance data stored in memory within bins according to days of the week. The identified day of the week is used as a reference to recall the historical distance data. At step 214 the controller may use the previously stored consumption rate and distance data to calculate expected upcoming energy consumption during the identified day. By using historical values tailored to a particular day, a more accurate prediction of the available driving distance of the current day may be achieved.

The expected energy consumption is added to the running energy estimate at step 216. The running energy estimate of overall predicted consumption is maintained and may include multiple days and/or drive cycles. For example, certain instances may not allow a driver to recharge the vehicle battery after a given day. Therefore at the beginning of the next drive cycle the battery may be less than fully charged. In at least one embodiment, the controller accounts for such a situation where there was no recharge following the previous drive cycle. If at step 218 the available energy stored in the battery is less than the running energy estimate, the controller predicts an available driving range based on the current day only because it is presumed that all available energy will be depleted during the current day at the historical consumption rate over the historical driving distance.

However, if at step 218 the available energy stored in the battery is greater than the running energy estimate, it is presumed that there will be stored energy remaining in the battery at the end of the current day. This remaining energy will be available for one or more upcoming days. At step 220 the controller indexes counter η to consider the consumption for the subsequent day. The controller returns to step 208 and realizes a new identified day corresponding to the subsequent day after the current day (i.e., current day+1). Similar to the current day calculation, the controller recalls the historical consumption rate and distance traveled for the new identified day at steps 210, 212 respectively. The controller calculates the expected total energy consumption for the new identified day at step 214 using the historical consumption rate and distance traveled during prior instances of the new identified day of the week.

The running energy estimate is then updated at step 216 by adding the expected energy consumption for the new identified day to the previous value for the running energy estimate. If at step 218 the available energy is greater than the updated running energy estimate, which in the example now accounts for two days, there still may be sufficient energy to provide driving distance for a third day. The controller may loop back to step 220, index counter η, and then repeat the process for each subsequent day until all available energy is accounted for. One aspect of the present disclosure is a range prediction algorithm that is capable of considering varying consumption rates and expected distances over a plurality of subsequent days assuming no battery recharge.

Once a running energy estimate is obtained which exceeds the available energy stored in the battery, the controller predicts the available driving distance at step 222 using all available energy. As described above, a number of days each having unique driving characteristics may be included in the prediction of overall distance. The controller provides at step 224 a DTE estimate value to the vehicle user interface to display an overall available driving distance.

Once a current drive cycle is underway, the controller monitors at step 226 the energy consumption rate and travel distance during the course of the current day. The data is stored to a memory of the controller to contribute to an energy consumption profile to be recalled to estimate DTE for subsequent calculations. At step 228 data indicative of the energy consumption rate of the current day are stored in separate bins corresponding to the day of the week. Similarly, at step 230 data indicative of the travel distance of the current day are stored in separate bins corresponding to the day of the week of the drive cycle.

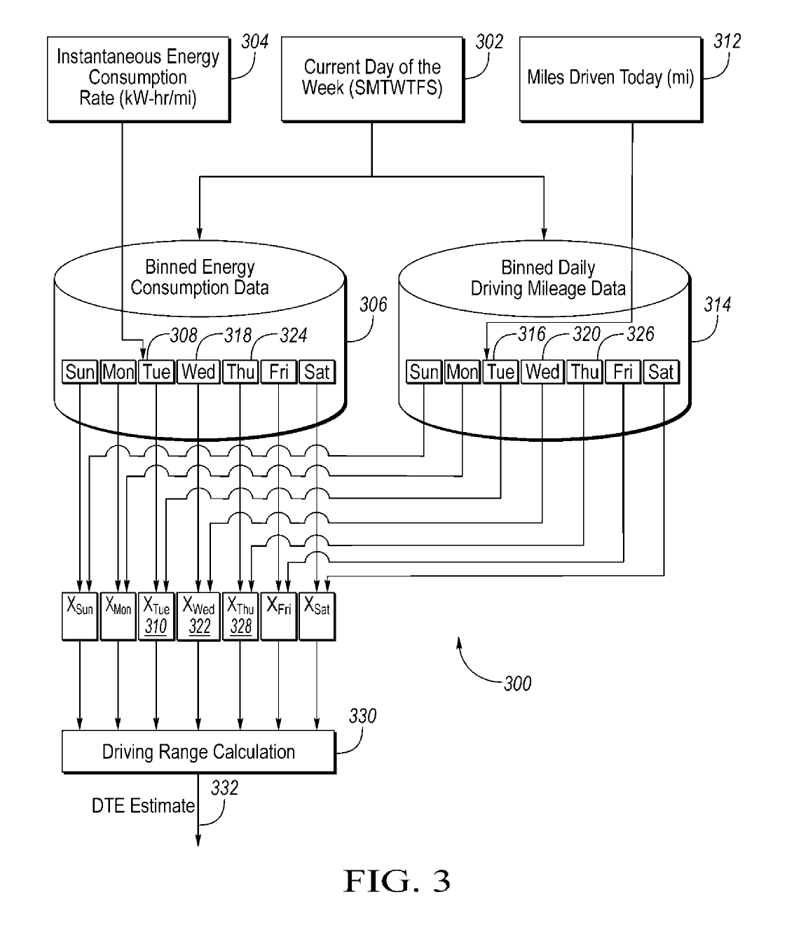

Referring to FIG. 3, a schematic of a vehicle driving distance indicator system 300 depicts an example of the data storage and information flow that may occur in one or more vehicle controllers. In this embodiment, driving categories are separated according to individual days of the week. The controller identifies the current day of the week 302. In the example of FIG. 3, Tuesday is used as an illustrative example. The controller receives the current instantaneous energy consumption rate 304. The controller recalls historical energy consumption data 306 stored in memory and binned according to days of the week. In the example, the controller recalls data 308 reflective of average energy consumption on Tuesdays. These data are input to an available driving distance calculation for the current day, which is discussed in more detail below.

In at least one embodiment, the controller may conduct a preliminary comparison between the instantaneous energy consumption rate and the historical average energy consumption rate of the relevant day of the week. If the instantaneous consumption rate sufficiently deviates from the historical rates, an adjustment factor may be applied to compensate for certain anomalies in expected driving patterns. If the instantaneous consumption rate is within a predetermined proximity of the historical rates for the current day of the week, a historical average consumption rate may be applied directly to calculate the DTE value for the current day.

The controller receives data indicating the mileage 312 previously driven during the current day. The controller recalls historical driving distance data 314 that is stored in memory and binned according to days of the week. In the example, the controller then recalls at 316, data regarding the average distance driven on Tuesdays. These data concerning driving distances are input to an available driving distance calculation for the current day. Expected energy consumption for the current day is calculated based on the average energy consumption rate and the average distances driven on previous instances of the current day of the week. In the example, expected energy consumption 310 for Tuesday is calculated.

As discussed above, if all available battery energy is not expected to be depleted during the current day, then subsequent days are considered until all available energy is accounted for. In at least one embodiment, the controller may also recall historical distances driven on the upcoming days of the week. In the example of FIG. 3, the available energy stored in the battery exceeds the amount expected to be consumed during driving on Tuesday. In this case, the stored energy consumption data 318 and driving distance data 320 corresponding to Wednesdays may then be recalled. The data may be used to calculate an expected energy consumption value 322 for Wednesday. The expected Wednesday consumption 322 may then be added to the expected Tuesday consumption 310, and the total running estimate then compared to the available energy stored in the battery. If the combined consumption of the two days does not exceed the available energy stored in the battery, a third day may be included in the estimate. In the example stored energy consumption data 324 and driving distance data 326 corresponding to Thursday may then be recalled. An expected Thursday consumption 328 is similarly added to the total running estimate. The estimation calculation continues to add subsequent days until the total expected consumption, where each day may have a unique profile, exceeds the total available energy stored in the battery.

The controller outputs the predicted available driving distance 330 using a sum of all days required to account for all available battery energy. Inputs from the expected energy consumption for the current day, as well as any relevant data from subsequent days if applicable, is used to generate an estimate of the distance available to be driven under the assumed upcoming driving conditions. This value is provided as a DTE estimate 332 and a vehicle display is updated to inform the driver.

Although averaging the stored data of previous drive cycles is shown by way of example, other formulas, algorithms, or lookup tables may be applied to the binned raw data of previous drive cycles to determine a suitable estimate for a particular day of the week. In one example, values stored within a bin may be weighted by time where more recent values may be more relevant and given increased weighting for the purposes of calculation. Also, smaller statistical distributions within a particular binned category may indicate higher consistency of driving patterns for a given category and similarly be given increased weighting. In an additional alternative embodiment, a neural network processor is used to learn driving patterns based on a collection of several different driving categories.

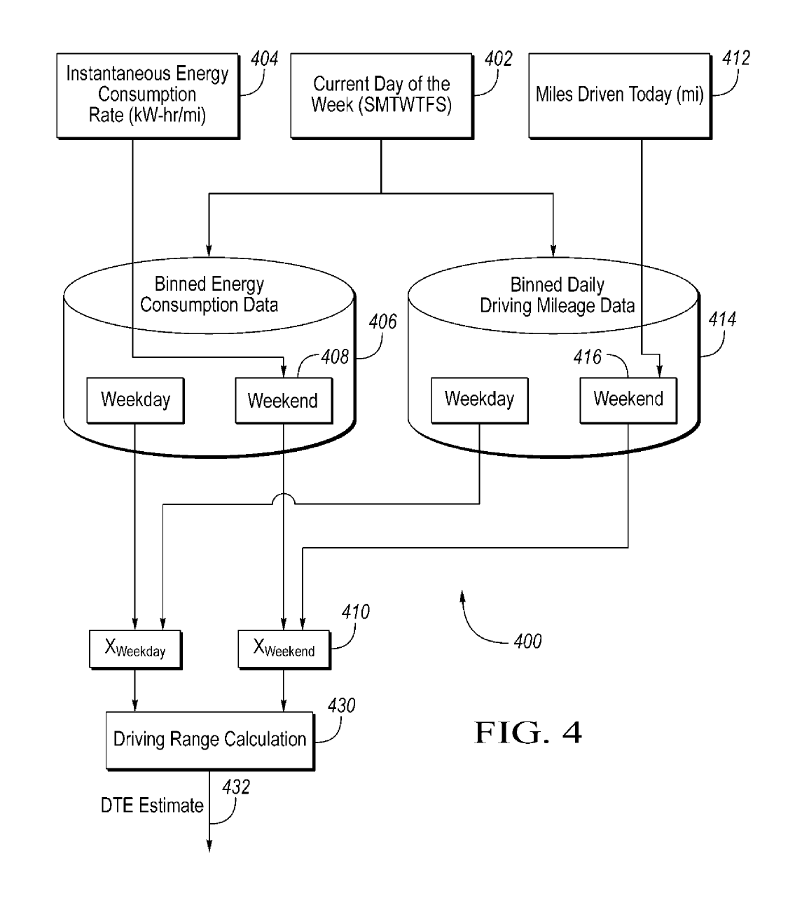

Referring to FIG. 4, a simplified binning technique is depicted where the controller is programmed to separate categories of stored driving data according to two categories of days: weekdays or weekend days. Similar reference numerals are used to correspond to certain similar aspects of the prior embodiment that uses individual days for binning data. If the resolution of a day-by-day driving profile is not required, the driving categories may be defined by broadly distinguishing weekday driving from weekend driving. One or more controllers of vehicle system 400 identifies the current day of the week 402. The controller receives the current instantaneous energy consumption rate 404. The controller recalls historical energy consumption data 406 stored in memory and binned according to weekdays versus weekend days. In the binning example of FIG. 4, average energy consumption stored data 408 corresponding to weekend days is recalled. These data are input to the calculation of expected weekend day energy consumption 410.

The controller receives data 412 indicating the mileage previously driven during the current day. The controller recalls historical driving distance data 414 that is stored in memory and binned according to occurrence on weekends or weekdays. The controller then recalls data 416 reflective of the average distance driven on weekend days. These data concerning driving distances are also input to the calculation of expected weekend day energy consumption 410. The expected energy consumption is estimated for the current day based on the average energy consumption rate and the average distance driven on previous corresponding weekend days or weekdays. Like previous embodiments, additional subsequent days may be included in a distance calculation when the expected energy consumption for the current day is less than the available energy stored in the battery. Sufficient additional days are included in the calculation until all available energy is accounted for.

Input from the available expected weekend day energy consumption 410, plus any additional days as applicable, is used to generate an estimate of the distance available to be driven under the assumed upcoming driving conditions. The controller outputs the predicted available driving distance 430. This value is provided as a DTE estimate 432 and a vehicle user interface is updated to display the information to the driver.

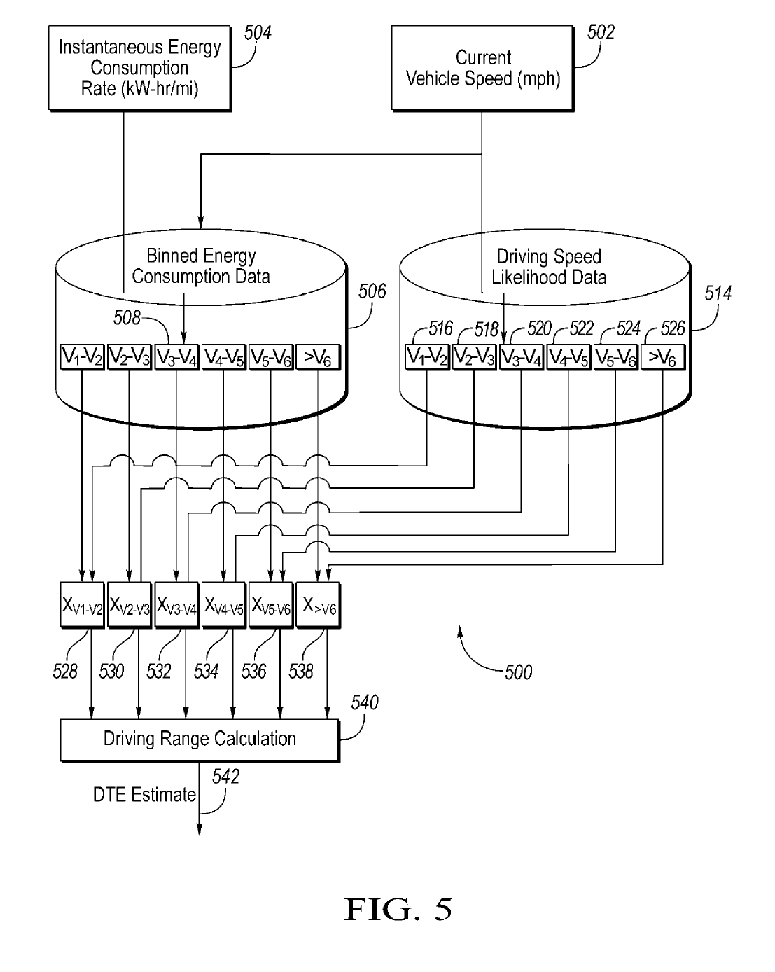

Referring to FIG. 5, a further embodiment including vehicle driving distance indicator system 500 is depicted. In this case, data associated with driving behavior is binned according to vehicle speed interval categories. Binning driving behavior according to vehicle speed data may be particularly useful for a driver that has a wide range of driving speeds, and where recent energy consumption history is not representative of upcoming patterns. The past speeds can be used to learn the likelihood of the vehicle traveling in a particular speed interval. The probabilities of each of the intervals are updated in an ongoing manner such that speed-based binning may be more responsive as compared to updating driving history following each driving cycle. In at least one embodiment, the likelihood of vehicle speed being within each speed interval is determined by the percentage of driving time that the vehicle is driven at speeds within the speed intervals.

The controller receives data 502 indicating the current vehicle speed. The controller also receives data 504 indicating the current instantaneous energy consumption rate. The controller may use these data to associate particular consumption rates with corresponding speed intervals. The controller recalls historical energy consumption data 506 stored in memory and binned according to separate speed intervals. In the example of FIG. 5, the controller recalls stored data 508 indicating the average energy consumption when the vehicle speed is in the interval ranging between vehicle speeds V₃ and V₄. Since vehicle speed is likely to change across intervals frequently during a single drive cycle, the database storing historical energy consumption rates constantly evolves.

Time spent driving within each of the speed intervals is stored to the historical driving speed likelihood data 514. The updated data continually affects the overall likelihood of vehicle travel within each speed interval.

One difference between the binning based on day of the week described above and a speed-based binning technique is the frequency of data processing. In the embodiment of FIG. 5, the likelihood of each vehicle speed interval is updated periodically. Each of the speed interval likelihood values 516, 518, 520, 522, 524, and 526 are repeatedly transmitted as they evolve for use in ongoing updates of the DTE estimate. Correspondingly, the expected energy consumption values 528, 530, 532, 534, 536, and 538 are updated in an ongoing fashion. The cumulative predicted energy usage for all of the speed intervals contributes to the available driving distance calculation 540. The controller provides a value for the updated DTE estimate 542 representing the available driving distance to the vehicle user interface for display to the driver.

Although six speed intervals are shown by way of example, any number of intervals may be employed to either increase the resolution of the estimate, or alternatively simplify the required calculations. Additionally, the thresholds of ranges may be non-uniformly spaced to account for speed ranges with higher sensitivity to acceleration and deceleration. In at least one alternative embodiment, two speed intervals are used, representing high speed and low speed. In such a case, the likelihood of various speeds may correspond to highway and city driving as different bins for driving profile data.

Additional binning methods are possible according to aspects of the present disclosure. A number of driving categories can be used to separate bins that may reflect different driving behaviors. For example, months of the year may correspond to different driving patterns, as drivers commonly exhibit different driving behavior throughout the year. Each of precipitation, temperature, humidity, aggressiveness of driver acceleration and deceleration all tend to exhibit annual patterns. Therefore, certain driving pattern changes may be predicted consistently from year to year. For example, depending on the climate there may be increased accessory loads from an air conditioning unit during warmer months, thereby increasing the energy consumption. Conversely, cold weather months associated with ice and snowy weather may cause slower or more cautious driving patterns. Binning driving categories according to months of the year may also account for regional weather pattern differences. Similarly, driving categories may be binned according to seasons of the year. Seasons may provide a more course binning criteria as compared to binning by month, yet still account for many of the factors mentioned above.

In further additional embodiments, external resistance factors may also provide criteria to bin data representing patterns of driving behavior. Learned driving patterns over different road grades or slopes may exhibit trends with respect to energy consumption. Also, road conditions such as surface friction corresponding to road type may also be suitable driving categories, such as paved roads as compared to brick or gravel roads. Since each of many road types cause different rolling resistance values, the energy consumption profile corresponding to each of the road types along a route may include characteristic aspects. Geographic data obtained from external maps or other internet sources allows the vehicle controller to utilize road type data in calculating available driving distances. In at least one embodiment, driving categories are binned according to rolling resistance values associated with different road types.

In still further additional embodiments, multiple driving categories may be binned in hierarchies such that there are high level categories, used in combination with subcategories corresponding to a different binning characteristic. This way, more driving factors affecting DTE estimation may be considered simultaneously, improving the accuracy of the model. In at least one embodiment, a high level driving category is binned according to day of the week as discussed above. In combination, a subcategory is applied to each bin to further parse the data into sub-bins to increase the resolution of the available driving distance calculation.

While the above method has been described largely with respect to HEVs, embodiments according to the present disclosure may also be suitable for use with BEVs, plug-in hybrid electric vehicles (PHEVs), as well as conventional vehicles.

The present disclosure provides representative control strategies and/or logic that may be implemented using one or more processing strategies such as event-driven, interrupt-driven, multi-tasking, multi-threading, and the like. As such, various steps or functions illustrated herein may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but it is provided for ease of illustration and description.

The control logic may be implemented primarily in software executed by a microprocessor-based vehicle, engine, and/or powertrain controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A distance indicator system for a vehicle comprising:
a display; and
a controller programmed to store energy consumption data and driving distance data from previous drive cycles for the vehicle according to day of week, and during a current drive cycle, output via the display an available driving distance based on an expected energy consumption rate and an expected driving distance each corresponding to the day of the week of the current drive cycle.

2. The system of claim 1 wherein the expected energy consumption rate and the expected driving distance are based, respectively, on an average of the stored energy consumption data and an average of the stored driving distance data corresponding to the day of the week of the current drive cycle.

3. The system of claim 1 wherein the controller is further programmed to, in response to an expected energy consumption being less than available battery energy, adjust the available driving distance based on expected energy consumption of a subsequent day of the week.

4. The system of claim 1 wherein the expected energy consumption rate and the expected driving distance are based, respectively, on an average of the stored energy consumption data and an average of the stored driving distance data for week days if the day of the week of the current drive cycle is a week day.

5. The system of claim 1 wherein the expected energy consumption rate and the expected driving distance are based, respectively, on an average of the stored energy consumption data and an average of the stored driving distance data for weekend days if the day of the week of the current drive cycle is a weekend day.

6. The system of claim 1 wherein the expected energy consumption rate is based on vehicle speed and wherein the controller is further programmed to store a percentage of driving time that the vehicle is driven at speeds within each of a plurality of speed intervals.

7. A method of indicating available drive distance for a vehicle comprising:
displaying, on a display, a predicted available driving distance for a current drive cycle of the vehicle that is based on stored energy consumption data and stored driving distance data associated with at least one of a plurality of driving categories, wherein criteria characterizing the current drive cycle correlates to criteria defining at least one of the driving categories.

8. The method of claim 7 wherein the criteria defining at least one of the categories is day of a week.

9. The method of claim 7 wherein the criteria defining at least one of the categories is speed interval.

10. The method of claim 7 wherein the criteria defining at least one of the categories is season of year.

11. The method of claim 7 wherein the criteria defining at least one of the categories is rolling resistance.

12. A vehicle comprising:
a powertrain;
a display; and
a controller programmed to store, from previous drive cycles, energy consumption data for the powertrain and speed data of the vehicle in speed interval categories, and to output via the display for a current drive cycle an available driving distance that is based on expected energy consumption and a likelihood of vehicle speed falling within each of the speed interval categories during the current drive cycle.

13. The vehicle of claim 12 wherein the speed interval categories include a highway driving speed category and a city driving speed category.

14. The vehicle of claim 12 wherein the controller is programmed to store a percentage of driving time that the vehicle is driven at speeds within each of a plurality of speed intervals.

15. The vehicle of claim 12 wherein the controller is further programmed to output the available driving distance based on day of week, season of year, road type or road grade.
